(19) United States
(12) Patent Application Publication
(10) Pub. No.: US 2006/0159315 A1
(43) Pub. Date: Jul. 20, 2006

(54) Method for manufacturing a sensor element for a gas sensor

(76) Inventor: Hans-Joerg Renz, Leinfelden-Echterdingen (DE)

Correspondence Address: KENYON & KENYON LLP, ONE BROADWAY, NEW YORK, NY, 10004, US

(21) Appl. No.: 11/297,083

(22) Filed: Dec. 7, 2005

(30) Foreign Application Priority Data
Dec. 7, 2004 (DE) 102004058802.3

(51) Int. Cl. H01C 7/00

(52) U.S. Cl. 382/124; 338/34; 204/424

(57) ABSTRACT

A method for manufacturing a sensor element for a gas sensor for determining a physical property of a test gas, particularly its temperature or the concentration of a gas component in a gas mixture, is provided, the sensor element having a hollow, finger-shaped solid electrolyte body, a measuring electrode resting outside on the solid electrolyte body, a reference electrode resting inside on the solid electrolyte body as well as circuit traces leading from the electrodes to contact areas. For a simplified manufacture of the finger shape of the sensor element with its mechanical advantages as compared to a planar sensor element, a planar carrier made of a deep-drawable ceramic material is printed on each of its carrier surfaces facing away from each other with a layer made of electrically conductive material in a defined geometric shape, and the printed carrier is deep-drawn into the finger shape.

### FIELD OF THE INVENTION

The present invention relates to a method for manufacturing a sensor element for a gas sensor for determining a physical property of a test gas, particularly its temperature or the concentration of a gas component in a gas mixture, such as the exhaust gas of an internal combustion engine.

### BACKGROUND INFORMATION

In a known electrochemical oxygen sensor for determining the oxygen content in the exhaust gas of internal combustion engines (German Patent Application No. DE 42 32 092), the finger-shaped sensor element is fixed in a sensor housing and protrudes from the housing with a segment bearing the electrodes. For protection against mechanical damage, a protective cap having gas entry holes is put over this protruding segment of the sensor element and is attached to the sensor housing. The sensor housing has a hex bolt and an external thread segment and at the mounting location is screwed into a connecting piece, which is inserted into an opening of a pipe carrying exhaust gas. The protective cap thereby passes through the opening in the pipe and projects into the exhaust gas flow.

This sensor element is generally manufactured in such a way that the electrodes, circuit traces and contact areas are mounted on a preformed, finger-like solid electrolyte body made of an oxygen ion-conducting ceramic material, preferably of yttrium-stabilized zirconium oxide, in a so-called pad-printing method. A layer made of a porous material is sintered onto the measuring electrode and onto its circuit trace lying on the outside of the ceramic body. A sensor element designed and manufactured in such a way is generally used as a λ=1 or voltage-jump sensor without or with heating. In the latter case, a sheath heater is inserted into the cavity of the finger-shaped ceramic body and is supplied with electricity.

Also known is a sensor element for a gas sensor (German Patent Application No. DE 199 41 051) having a planar, laminated solid electrolyte body. The measuring and the reference electrode as well as an inner and an outer pump electrode with corresponding circuit traces and contact areas laid onto the surface of the planar body are printed onto several superposed ceramic layers. In addition, an electrical resistor track for an electrical heater may be inserted between two ceramic layers, which is embedded into an electrical insulation, preferably made of aluminum oxide. As so-called blank foils, preferably made of yttrium-stabilized zirconium oxide, the individual ceramic layers are printed with the electrode material, preferably platinum, as well as with the electrical resistor track and the insulation, are then laminated together with the aid of foil binder and are subsequently sintered. The planar sensor element is in turn inserted into a sensor housing and protrudes with its electrode segment out of the sensor housing where it is surrounded by a protective sleeve for protection against mechanical damage. Such a sensor element is used preferably for lean sensors or broadband-lambda sensors.

### SUMMARY OF THE INVENTION

The method according to the present invention for manufacturing a sensor element for a gas sensor has the advantage that in spite of the desired finger-shape of the sensor element, having its mechanical advantages in comparison with a planar sensor element, simple coating and printing techniques may be used as are used in the manufacture of planar sensor elements. The solid electrolyte body may be manufactured as a monolith or as a laminate made up of a plurality of foils such that not only a voltage-jump sensor may be implemented in a finger shape, but a lean sensor, a broadband-lambda sensor, a nitrogen oxide sensor, a temperature sensor and the like may also be equipped with a finger-shaped sensor element. Due to the rounded shape of the finger-shaped solid electrolyte body, a costly grinding of the edges, which must be undertaken in planar sensor elements to avoid problems in the edge region due to temperature gradients, is not required. In contrast to the planar element, the finger-shaped sensor element is immune to warping and bending.

According to an advantageous specific embodiment of the present invention, the deep drawing is performed in a heated deep-drawing mold, the printed, planar ceramic carrier being drawn into the deep-drawing mold by vacuum. Alternatively, the ceramic body may also be deep-drawn with the aid of a deep-drawing punch, which is placed onto the surface of the ceramic carrier facing away from the deep-drawing mold.

A sensor element manufactured using the method according to the present invention is also provided.

### BRIEF DESCRIPTION OF THE DRAWINGS

FIG. 1 shows a perspective view of a sensor element.

FIG. 2 shows a longitudinal section of the sensor element in FIG. 1.

FIG. 3 shows the detail of a cross section of a printed, planar carrier for manufacturing the sensor element in FIG. 1 and FIG. 2.

FIG. 4 shows a bottom view in the direction of arrow IV in FIG. 3 of the carrier with the layer of porous material removed.

FIG. 5 shows the same representation as in FIG. 3 of a modified, printed, planar carrier.

FIG. 6 shows a schematic presentation of a longitudinal section of a deep-drawing mold having a printed, planar carrier inside of it.

### DETAILED DESCRIPTION

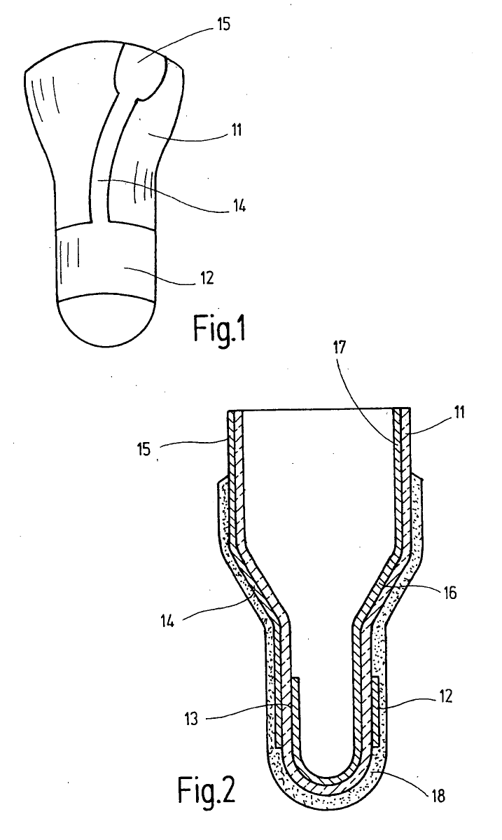

The sensor element for a gas sensor shown in FIG. 1 in perspective and in FIG. 2 in a longitudinal section is conceived for a so-called λ=1 sensor or voltage-jump sensor for determining the oxygen concentration in the exhaust gas of an internal combustion engine. It has a hollow, finger-shaped solid electrolyte body 11 made of yttrium-stabilized zirconium oxide (ZrO₂), a measuring electrode 12 exposed to the exhaust gas and a reference electrode 13 exposed to a reference gas, preferably air. Measuring electrode 12 is situated on the outside of solid electrolyte body 11 in the lower segment of the body and is connected to a contact area 15 situated in the upper segment of the body via a circuit trace 14. Reference electrode 13 is likewise situated in the lower segment of solid electrolyte body 11 on its surface surrounding the cavity and also covers the rounded bottom region of solid electrolyte body 11. Reference electrode 13 is connected to a contact area 17 situated in the upper segment of the body via a circuit trace 16. Measuring electrodes 12, 13 with their associated circuit traces 14, 16 and contact areas 15, 17 are made of electrically conductive material, preferably platinum or a platinum cermet. Contact areas 15, 17 are used for connecting measuring and reference electrode 12, 13 to an evaluation electronics. Measuring electrode 12 and associated circuit trace 14 on the outside of solid electrolyte body 11 is covered by a porous protective layer 18 made of ceramic material, preferably aluminum oxide (Al₂O₃). In the perspective representation of the sensor element in FIG. 1, porous protective layer 18 is omitted for the purpose of illustrating the arrangement of measuring electrode 12, circuit trace 14 and contact area 15. The sensor element thus constructed is accommodated in a sensor housing not shown here, as is described for example in German Patent Application No. DE 42 32 092, the lower body segment carrying the measuring and reference electrode 12, 13 protruding from the housing, being covered by a protective cap and exposed to the exhaust gas passing through the gas passage holes in the protective cap.

Sensor element 11 shown in FIGS. 1 and 2 is manufactured as follows:

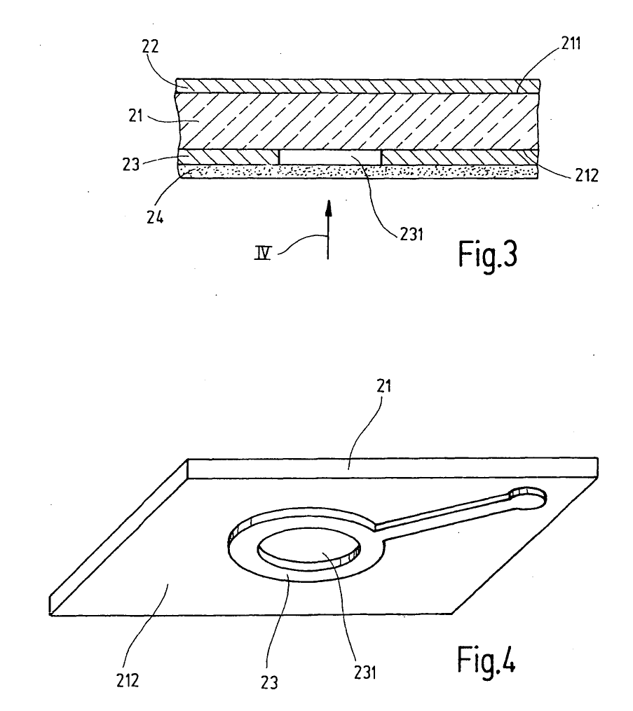

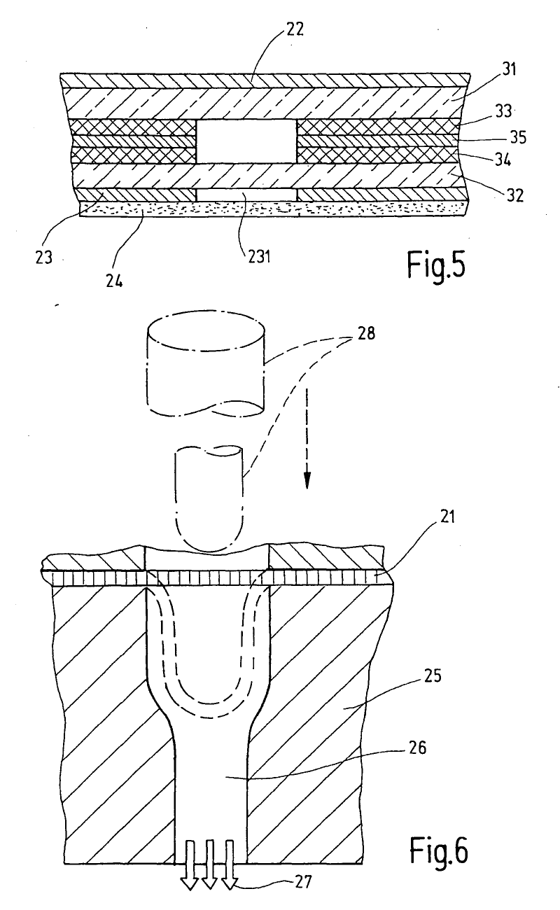

A flat or planar carrier 21 made of a deep-drawable ceramics, preferably a paste made of yttrium-stabilized zirconium oxide, is printed on its carrier surfaces 211, 212 facing away from each other respectively with a layer 22 and 23 made of an electrically conductive material, preferably platinum or a platinum cermet, in a defined geometric shape (FIG. 3). The geometric shape is predefined in such a way that by subsequent deep-drawing of the printed planar carrier 21 the electrically conductive material covers each carrier surface 211 and 214 in the desired layout of electrode 12 or 13, circuit traces 14 or 16 and contact areas 15 or 17, as shown in FIGS. 1 and 2. Since by way of example measuring electrode 12 is designed as a ring on the outer surface of solid electrolyte body 11, the lower layer 23 in FIG. 3 made of electrically conductive material must therefore have a circular ring-shaped opening 231. Layer 23, printed on lower carrier surface 212 for obtaining measuring electrode 12, circuit trace 14 and contact area 15 in the configuration (layout) shown in FIGS. 1 and 2 is shown in FIG. 4 in perspective. Following deep-drawing, the circular ring-shaped part of the layer forms measuring electrode 12, the approximately diagonally running elongated segment forms circuit trace 14 and the widened terminal segment at the end of the elongated segment forms what later will widened terminal segment at the end of the elongated segment forms what later will be contact area 15 on solid electrolyte body 11 formed by carrier 21. Another layer 24 made of porous material, the material preferably being made up of aluminum oxide with pore-forming material, e.g. soot powder, which burns up in the sinter process, is printed onto lower layer 23 made of electrically conductive material.

Planar carrier 21 printed in this manner is inserted into a deep-drawing mold 25 shown in FIG. 6 in a longitudinal section in a cutaway view. Deep-drawing mold 25 has a deep-drawing channel 26 which defines the form of the finger-shaped sensor element. When inserting planar carrier 21, porous layer 24 is facing the opening of deep-drawing channel 26 and planar carrier 21 is inserted into deep-drawing form 25 in such an orientation that cut-out 231 in layer 23 lies coaxially with respect to deep-drawing channel 26. Now a vacuum (arrows 27) is generated at the end of deep-drawing channel 26 facing away from ceramic carrier 21, as a result of which printed carrier 21 is drawn into deep-drawing channel 26 as indicated in FIG. 6 by dashed lines. At the end of the deep-drawing process, printed carrier 21 has the shape shown in FIG. 1. Alternatively, printed, planar carrier 21 may also be pressed into deep-drawing channel 26 with the aid of a deep-drawing punch, as indicated in FIG. 6 by a dot-dash line. Subsequently, deep-drawn, printed carrier 21 is subjected to a sintering process.

So that the sensor element reaches its operating temperature as quickly as possible when cold starting, it may be equipped with an integrated electrical heater. For this purpose, carrier 21 is designed in a laminated fashion and is composed of several ceramic layers or blank foils, in the exemplary embodiment in FIG. 3 of ceramic layers 31 and 32. A resistor track embedded between two insulating layers 33, 34 made of aluminum oxide is situated between ceramic layers 31, 32. For this purpose, insulating layers 33, 34 are printed onto the mutually facing sides of ceramic layers 31, 32, and a layer 35 made of an electrically conductive material is printed onto one of the insulating layers 33 in such a geometric shape that following deep-drawing it takes on the shape of the desired resistor track. The two ceramic layers 31, 32 printed in this manner are combined with the aid of foil binder via insulating layers 33, 34 to form ceramic carrier 21, and the latter is printed on its outer sides with layers 22, 23 and 24 in the manner described and is subsequently deep-drawn and sintered.

The method according to the present invention may be used in an equally advantageous manner also for manufacturing a finger-shaped sensor element, which is used as a lean sensor or broadband-lambda sensor having pump electrodes or as a nitrogen oxide sensor for a gas sensor for determining the concentration of nitrogen oxides in the exhaust gas of internal combustion engines or as a sensor element for a temperature sensor for exhaust gases.

What is claimed is:

1. A method for manufacturing a sensor element for a gas sensor for determining a physical property of a test gas, comprising:
providing a hollow, finger-shaped solid electrolyte body, a measuring electrode resting outside on the solid electrolyte body, a reference electrode resting inside on the solid electrolyte body, and circuit traces leading from the electrodes to contact areas;
printing a planar carrier made of a deep-drawable ceramic on each of a plurality of carrier surfaces facing away from each other with at least one layer made of electrically conductive material in a defined, geometric shape; and
deep-drawing the printed carrier into a finger form.

2. The method according to claim 1, wherein the method is for determining at least one of a temperature and a concentration of a gas component in a gas mixture.

3. The method according to claim 1, wherein the at least one layer made of electrically conductive material is geometrically shaped in such a way that, by deep-drawing, the electrically conductive material covers every carrier surface in a desired layout of at least one of the electrodes, the circuit traces and the contact areas.

4. The method according to claim 1, further comprising printing a further layer made of a deep-drawable, porous material, including an aluminum oxide laced with pore-forming material, onto the layer lying on the outside during deep-drawing and made of electrically conductive material.

5. The method according to claim 1, further comprising subjecting the printed carrier to a sintering process following deep drawing.

6. The method according to claim 1, wherein the planar carrier is composed of at least two ceramic layers, including ceramic blank foils, and further comprising printing an insulating layer on each of mutually facing sides of the ceramic layers and printing a layer made of electrically conductive material onto one of the insulating layers in such a way that deep drawing produces an electrical resistor track in a desired shape between the ceramic layers.

7. The method according to claim 1, wherein a paste made of yttrium-stabilized zirconium oxide is used as a deep-drawable ceramic.

8. The method according to claim 1, wherein one of platinum and a platinum cermet is used as an electrically conductive material.

9. The method according to claim 1, wherein the deep drawing is performed in a heated deep-drawing mold.

10. A sensor element for a gas sensor for determining a physical property of a test gas, comprising:
a hollow, finger-shaped solid electrolyte body;
a measuring electrode resting outside on the solid electrolyte body;
a reference electrode resting inside on the solid electrolyte body; and
circuit traces leading from the electrodes to contact areas,
wherein the solid electrolyte body having a layout, situated on an inner and outer surface, of at least one of the electrodes, the circuit traces and the contact areas is a deep-drawn part made of a planar ceramic body that is printed with a layer of electrically conductive material of a predefined geometric shape on each of carrier surfaces that are facing away from each other.

11. The sensor element according to claim 10, wherein the sensor element is for determining at least one of a temperature and a concentration of a gas component in a gas mixture.
